(19) United States
(12) Patent Application Publication
(10) Pub. No.: US 2009/0097470 A1
(43) Pub. Date: Apr. 16, 2009

(54) METHODS AND SYSTEMS FOR COMMUNICATING DATA

(76) Inventors: David S. Collier, Charlottesville, VA (US); Catherine Mary Hewlett Elliott, Ruckersville, VA (US); David Charles Elliott, Ruckersville, VA (US); Carson Ward Lankford, JR., Charlottesville, VA (US); Roy Noyes, Charlottesville, VA (US); Dean Talley, Barboursville, VA (US)

Correspondence Address: General Electric Company;GE Global Patent Operation, PO Box 861, 2 Corporate Drive, Suite 648, Shelton, CT, 06484, US

(21) Appl. No.: 11/871,260

(22) Filed: Oct. 12, 2007

(51) Int. Cl. H04L 12/28

(52) U.S. Cl. 370/351

(57) ABSTRACT

A method for communicating data is provided. The method includes transmitting a first request from a first device to an embedded device via a first network using a first protocol, wherein the first request includes a second request formatted according to a second protocol. The method also includes transmitting the second request from the embedded device to a second device via a second network using the second protocol.

### BACKGROUND OF THE INVENTION

This invention relates generally to client-server communication and, more specifically, to client-server communications involving multiple networks and multiple communication protocols.

At least some known networked systems include network devices that are not all connected together using the same network. Moreover, at least some known networked devices require specific communication protocols that are not compatible with each other. As a result, often such networked devices are unable to communicate with each other without additional hardware or software. Accordingly, at least some known networked systems include a central access point that is directly connected to all of the networks in the system. Alternatively, at least some known networked systems include a gateway device that is specifically designed to convert from one network and/or protocol to another network and/or protocol. Either of such approaches requires, for example, additional network interface modules, additional wiring, and/or special hardware. Such additions to the networked system require additional equipment, implementation, maintenance, and development costs.

Moreover, at least some known networked systems that use specialized hardware to convert from one network and/or protocol to another are not easily extensible. As such, as new networked devices are added to such systems, each newly formed network requires an additional network interface module, additional wiring, and/or additional special hardware.

### BRIEF DESCRIPTION OF THE INVENTION

In one aspect, a method for communicating data is provided. The method includes transmitting a first request from a first device to an embedded device via a first network using a first protocol, wherein the first request includes a second request formatted according to a second protocol. The method also includes transmitting the second request from the embedded device to a second device via a second network using the second protocol.

In another aspect, a system for communicating data over a plurality of networks using a plurality of transport protocols is provided. The system includes a plurality of devices, at least one embedded device communicatively coupled to a first device of the plurality of devices via a first network and to a second device of the plurality of devices via a second network. The at least one embedded device is configured to receive a first request from the first device using a first transport protocol, wherein the first request includes a second request formatted according to a second transport protocol. The at least one embedded device is also configured to transmit the second request to the second device using the second protocol.

In another aspect, a method is provided for using an embedded device to transport protocol data units (PDUs) of multiple protocols over multiple networks. The embedded device includes at least one network interface configured to communicate with a first device of a plurality of devices via a first network using a first protocol and with a second device of the plurality of devices via a second network using a second protocol. The method includes receiving a request from the first device via the first network using the first protocol, wherein the request includes a request PDU formatted according to the second protocol. The method also includes routing the request PDU to the second device, wherein the request includes a network address of the second device, and wherein the request PDU is routed to the second device via the second network using the second protocol.

### BRIEF DESCRIPTION OF THE DRAWINGS

FIGS. 1 and 2 show exemplary embodiments of the systems and methods described herein. The systems and methods shown in FIGS. 1 and 2, and described in conjunction with FIGS. 1 and 2, are exemplary only.

FIG. 1 is a diagram of an exemplary network protocol transport system; and

FIG. 2 is a flow chart illustrating an exemplary method of communicating data within a system, such as the network protocol transport system shown in FIG. 1.

### DETAILED DESCRIPTION OF THE INVENTION

Set forth below are descriptions of exemplary systems and methods for use in communicating data in an automation system. The technical effect of the described embodiments is to provide systems and methods that enable one or more clients communicating with an embedded device, such as an automation controller including a programmable logic controller (PLC), via a first network and using a first protocol, to also communicate with one or more servers using a second protocol, wherein the one or more servers are connected to the embedded device via a second network. The methods and systems are not limited to the specific embodiments described herein. Rather, in addition, components of each system and steps of each method can be practiced independent and separate from other components and steps described herein. Moreover, each component and step can also be used in combination with other components and steps.

As used herein, the term “protocol” refers to a standard or a proprietary that controls the connection and/or communication between two endpoints. A protocol may be implemented via hardware, software, or a combination of both hardware and software. A protocol specifies properties such as, but not limited to, negotiation of connection and/or communication characteristics, how to start and/or end a message between the endpoints, a format of a message, error detection, and termination of a connection and/or communication. Examples of common protocols include, but are not limited to only including, Internet Protocol (IP), Dynamic Host Configuration Protocol (DHCP), Transmission Control Protocol (TCP), Hypertext Transmission Protocol (HTTP), and File Transfer Protocol (FTP).

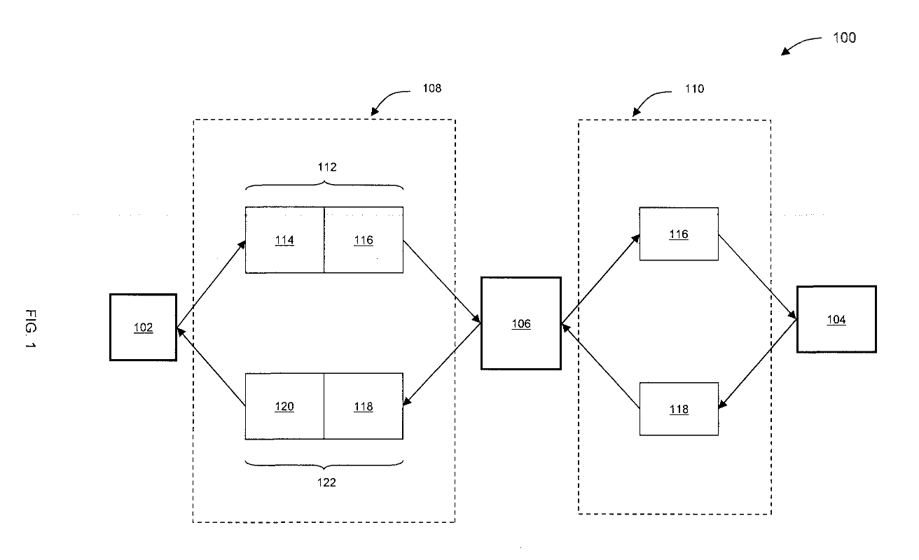

FIG. 1 is a diagram of an exemplary network protocol transport system 100. In the exemplary embodiment, system 100 includes at least one client 102, at least one server 104, and at least one embedded device 106. Client 102 is communicatively coupled to embedded device 106 via a first network 108 and communicates with embedded device 106 using a first protocol. Server 104 is communicatively coupled to embedded device 106 via a second network 110 and communicates with embedded device 106 using a second protocol. In the exemplary embodiment, the first and second networks 108 and 110 use different protocols. As such, client 102 is unable to communicate directly with server 104 without the protocol transport functionality of embedded device 106. In one embodiment, first network 108 and/or second network 110 is a wide area network (WAN), such as the Internet. In another embodiment, first network 108 and/or second network 110 is a local area network (LAN), such as an intranet. First network 108 and/or second network 110 include physical medium and intermediate devices (not shown), such as but not limited to, routers and switches, that connect the elements of system 100 described above.

In the exemplary embodiment, client 102 is communicatively connected to first network 108 via a network interface (not shown). A user interfaces with client 102 to gain access to system 100. Client 102 may connect to first network 108 through many interfaces including a different network (not shown), such as a WAN or a LAN, dial in connections, cable modems, and special high-speed ISDN lines. Client 102 is any device that is capable of interconnecting to first network 108, including but not limited to, a web-based telephone or any other web-based connectable equipment. Client 102 may be a stand-alone client, such as a thin client, that runs only an operating system and an application that enables accessing and communicating with system 100. Alternatively, client 102 may operate as an application that is installed on a personal computer (PC) and may be executed similarly and/or concurrently with other programs. Client 102 also includes a system memory (not shown) that is electrically connected to a system bus (not shown) and, in one embodiment, includes an operating system and a user-oriented program and data. In the exemplary embodiment, client 102 also includes user interaction devices such as, but not limited to, a display, a keyboard, and/or a mouse (not shown). In the exemplary embodiment, client 102 communicates with embedded device 106 via first network 108 and using a first protocol. In one embodiment, client 102 is configured to receive data “pushed” from embedded device 106 such that it is unnecessary for client 102 to make a request to embedded device 106 in order to receive data. In an alternative embodiment, client 102 is configured to receive data from embedded device 106 only after client 102 requests the data (i.e., “pulls” the data). In another alternative embodiment, client 102 is configured to receive data from embedded device 106 using a “push” and/or a “pull” mode of communicating. In a further alternative embodiment, client 102 is configured to send unidirectional requests to server 104 via embedded device 106 such that server 104 does not and/or is not required to provide responses to the requests. Similarly, server 104 may be configured to send unidirectional requests to client 102 via embedded device 106 such that client 102 does not and/or is not required to provide responses to the requests.

In the exemplary embodiment, server 104 is communicatively coupled to second network 110 via a network interface (not shown). Server 104 includes a system memory (not shown) that is electrically connected to a system bus (not shown) and, in one embodiment, includes an operating system. In the exemplary embodiment, server 104 communicates with embedded device 106 via second network 110 and using a second protocol different from the first protocol.

During operation, due to differing network properties and the use of different protocols between first network 108 and second network 110, client 102 and server 104 are unable to directly communicate with each other. Rather, in the exemplary embodiment, embedded device 106 functions as a “transport medium” enabling any protocol, such as the second protocol, to be transported from client 102 to server 104.

In the exemplary embodiment, client 102 generates and transmits a request 112 to embedded device 106 via first network 108 using the first protocol. Request 112 includes a request wrapper 114 and a request protocol data unit (PDU) 116. In the exemplary embodiment, request PDU 116 is formatted as specified by the second protocol. In the exemplary embodiment, request wrapper 114 includes information for routing request PDU 116 through embedded device 106 and to server 104. In one embodiment, the information for routing request PDU 116 includes the network address of server 104. In an alternative embodiment, the information for routing request PDU 116 includes a network address of more than one server 104. Embedded device 106 receives request 112 and transmits request PDU 116 to server 104.

In the exemplary embodiment, server 104 interprets request PDU 116 and generates a response PDU 118. In the exemplary embodiment, response PDU 118 is formatted as specified by the second protocol. Server 104 transmits response PDU 118 to embedded device 106. Embedded device 106 generates a response wrapper 120, and packages response wrapper 120 and response PDU 118 into a response 122. In the exemplary embodiment, response wrapper 120 includes a count of response PDUs 118 that are returned to embedded device 106. Additionally, in one embodiment, response wrapper 120 includes the network address of server 104. In an alternative embodiment, response wrapper 120 includes a network address of more than one server 104. Embedded device 106 then transmits the response 122 to client 102.

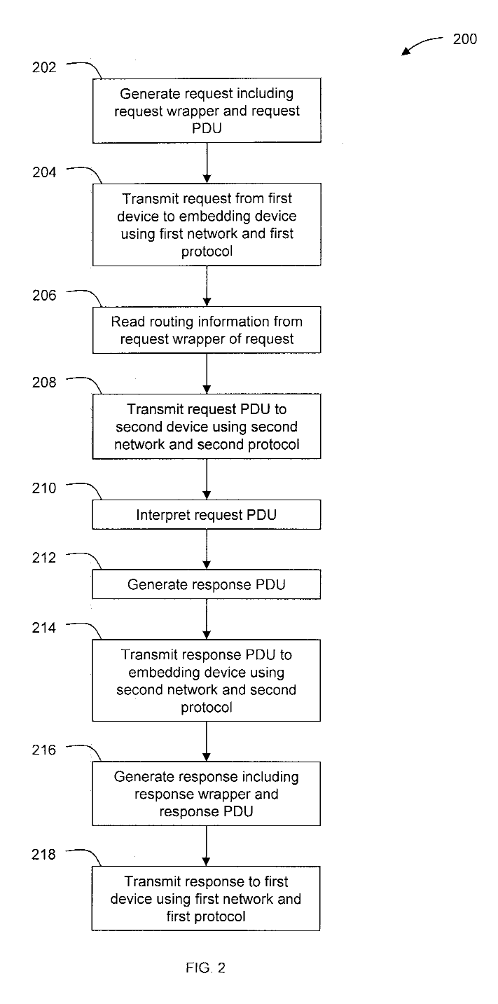

FIG. 2 is a flow chart illustrating an exemplary method 200 for communicating data within a system, such as system 100 (shown in FIG. 1). Referring to FIG. 1, client 102 generates 202 request 112 that includes request wrapper 114 and request protocol data unit (PDU) 116. Client 102 then transmits 204 data request 112 to embedded device 106 via first network 108 and using a first protocol. Request wrapper 114 includes routing information used by embedded device 106 in transmitting request PDU 116 to server 104. In one embodiment, the routing information includes a server network address for server 104. In an alternative embodiment, system 100 includes a plurality of servers 104 and the routing information is used by embedded device 106 to transmit request PDU 116 to one or more servers 104. In the exemplary embodiment, request PDU 116 is generated by client 102 and is formatted as specified by a second protocol that is different than the first protocol.

In the exemplary embodiment, embedded device 106 receives request 112 and processes 206 the routing information from request wrapper 114. Embedded device 106 then transmits 208 request PDU 116 to server 104 via second network 110 and using the second protocol.

In the exemplary embodiment, server 104 receives and interprets 210 request PDU 116. Interpretation 210 of request PDU 116 by server 104 is enabled because request PDU 116 is formatted as specified by the second protocol. In the exemplary embodiment, after interpreting 210 request PDU 116, server 104 generates 212 response PDU 118. Response PDU 118 is formatted as specified by the second protocol. Server 104 then transmits 214 response PDU 118 to embedded device 106 via second network 110 and using the second protocol.

In the exemplary embodiment, embedded device 106 generates 216 response 122. Response 122 includes response wrapper 120 and response PDU 118. In the exemplary embodiment, embedded device 106 creates response wrapper 120, which includes a count of response PDUs 118 being transmitted and the network address of server 104. In an alternative embodiment, response wrapper 120 includes a count of response PDUs 118 being transmitted and a server network address of each server 104 to which request 112 was transmitted 208 by embedded device 106. In such an embodiment, response 122 includes multiple response PDUs 118 that are each generated 216 by a separate server 104. In the exemplary embodiment, embedded device 106 then transmits 218 response 122 to client 102 via first network 108 and using the first protocol.

In the exemplary embodiment, the flow of communication in method 200 may be reversed. As such, server 104 generates 202 request 112 that includes request wrapper 114 and request protocol data unit (PDU) 116. Server 104 then transmits 204 data request 112 to embedded device 106 via second network 110 and using a second protocol. Request wrapper 114 includes routing information used by embedded device 106 in transmitting request PDU 116 to client 102. In one embodiment, the routing information includes a client network address for client 102. In an alternative embodiment, system 100 includes a plurality of clients 102 and the routing information is used by embedded device 106 to transmit request PDU 116 to one or more clients 102. In the exemplary embodiment, request PDU 116 is generated by server 104 and is formatted as specified by a first protocol that is different than the second protocol.

In the exemplary embodiment, embedded device 106 receives request 112 and processes 206 the routing information from request wrapper 114. Embedded device 106 then transmits 208 request PDU 116 to client 102 via first network 108 and using the first protocol.

In the exemplary embodiment, client 102 receives and interprets 210 request PDU 116. Interpretation 210 of request PDU 116 by client 102 is enabled because request PDU 116 is formatted as specified by the first protocol. In the exemplary embodiment, after interpreting 210 request PDU 116, client 102 generates 212 response PDU 118. Response PDU 118 is formatted as specified by the first protocol. Client 102 then transmits 214 response PDU 118 to embedded device 106 via first network 108 and using the first protocol.

In the exemplary embodiment, embedded device 106 generates 216 response 122. Response 122 includes response wrapper 120 and response PDU 118. Response PDU 118 is formatted as specified by the first protocol. In the exemplary embodiment, embedded device 106 creates response wrapper 120, which includes a count of response PDUs 118 being transmitted and the network address of client 102. In an alternative embodiment, response wrapper 120 includes a count of response PDUs 118 being transmitted and a client network address of each client 102 to which request 112 was transmitted 208 by embedded device 106. In such an embodiment, response 122 includes multiple response PDUs 118 that are each generated 216 by a separate client 102. In the exemplary embodiment, embedded device 106 then transmits 218 response 122 to server 104.

In an alternative embodiment, client 102 is configured to send a unidirectional request 112 to server 104, to which server 104 is not required to respond. As such, client 102 generates 202 request 112 that includes request wrapper 114 and request protocol data unit (PDU) 116. Client 102 then transmits 204 data request 112 to embedded device 106 via first network 108 and using a first protocol. Request wrapper 114 includes routing information used by embedded device 106 in transmitting request PDU 116 to server 104. In one embodiment, the routing information includes a server network address for server 104. In an alternative embodiment, system 100 includes a plurality of servers 104 and the routing information is used by embedded device 106 to transmit request PDU 116 to one or more servers 104. In the exemplary embodiment, request PDU 116 is generated by client 102 and is formatted as specified by a second protocol that is different than the first protocol.

In the exemplary embodiment, embedded device 106 receives request 112 and processes 206 the routing information from request wrapper 114. Embedded device 106 then transmits 208 request PDU 116 to server 104 via second network 110 and using the second protocol. In the exemplary embodiment, server 104 receives and interprets 210 request PDU 116. Interpretation 210 of request PDU 116 by server 104 is enabled because request PDU 116 is formatted as specified by the second protocol. In the exemplary embodiment, after interpreting 210 request PDU 116, server 104 processes the action included in request PDU 116 but does not generate a response PDU 118.

Similarly, server 104 may be configured to send a unidirectional request 112 to client 102, to which client 102 is not required to respond. As such, server 104 generates 202 request 112 that includes request wrapper 114 and request protocol data unit (PDU) 116. Server 104 then transmits 204 data request 112 to embedded device 106 via second network 110 and using a second protocol. Request wrapper 114 includes routing information used by embedded device 106 in transmitting request PDU 116 to client 102. In one embodiment, the routing information includes a client network address for client 102. In an alternative embodiment, system 100 includes a plurality of clients 102 and the routing information is used by embedded device 106 to transmit request PDU 116 to one or more clients 102. In the exemplary embodiment, request PDU 116 is generated by server 104 and is formatted as specified by a first protocol that is different than the second protocol.

In the exemplary embodiment, embedded device 106 receives request 112 and processes 206 the routing information from request wrapper 114. Embedded device 106 then transmits 208 request PDU 116 to client 102 via first network 108 and using the first protocol. In the exemplary embodiment, client 102 receives and interprets 210 request PDU 116. Interpretation 210 of request PDU 116 by client 102 is enabled because request PDU 116 is formatted as specified by the first protocol. In the exemplary embodiment, after interpreting 210 request PDU 116, client 102 processes the action included in request PDU 116 but does not generate a response PDU 118.

The above-described systems and methods facilitate using multiple networks and multiple protocols for communicating between clients and servers. More specifically, the systems and methods described herein facilitate enabling clients connected and communicating with a embedded device via a first network using a first protocol, to also communicate with one or more servers connected and communicating with the embedded device via a second network using a second protocol. The embedded device, for example, an automation controller including a programmable logic controller (PLC), functions as a “transport medium” and enables the second protocol to be transported from the client to one or more servers, even where the client and the servers are connected to different networks and/or use different protocols.

In summary, in one embodiment, a method for communicating data is provided. The method includes transmitting a first request from a first device to an embedded device via a first network using a first protocol, wherein the first request includes a second request formatted according to a second protocol. In an alternative embodiment, transmitting the first request to the embedded device includes generating the first request, wherein the first request further includes a request wrapper.

Moreover, the method also includes transmitting the second request from the embedded device to a second device via a second network using the second protocol. In an alternative embodiment, transmitting the second request to the second device includes reading routing information from the first request and routing the second request to the second device via the second network using the second protocol, wherein the second request is routed according to the routing information.

In an alternative embodiment, the method also includes transmitting a first response from the second device to the embedded device via the second network using the second protocol and transmitting a second response from the embedded device to the first device via the first network using the first protocol, the second response including the first response. In another alternative embodiment, transmitting a first response to the embedded device includes interpreting the second request, generating the first response, and transmitting the first response to the embedded device via the second network using the second protocol. In a further alternative embodiment, the method also includes generating the second response, wherein the second response further includes a response wrapper, and transmitting the response to the first device via the first network using the first protocol.

As used herein, an element or step recited in the singular and proceeded with the word “a” or “an” should be understood as not excluding plural said elements or steps, unless such exclusion is explicitly recited. Further, references to one embodiment of the present invention are not intended to be interpreted as excluding the existence of additional embodiments that also incorporate the recited features.

Exemplary embodiments of systems and methods for enabling a client to communicate with one or more servers using multiple networks and multiple protocols are described above in detail. The systems and methods are not limited to the specific embodiments described herein, but rather, components of the systems and/or steps of the methods may be utilized independently and separately from other components and/or steps described herein. Further, the described system components and/or method steps can also be defined in, or used in combination with, other systems and/or methods, and are not limited to practice with only the systems and methods as described herein.

While the invention has been described in terms of various specific embodiments, those skilled in the art will recognize that the invention can be practiced with modification within the spirit and scope of the claims.

What is claimed is:

1. A method for communicating data, said method comprising:
transmitting a first request from a first device to an embedded device via a first network using a first protocol, the first request including a second request formatted according to a second protocol; and
transmitting the second request from the embedded device to a second device via a second network using the second protocol.

2. A method in accordance with claim 1 further comprising:
transmitting a first response from the second device to the embedded device via the second network using the second protocol; and
transmitting a second response from the embedded device to the first device via the first network using the first protocol, the second response including the first response.

3. A method in accordance with claim 2 wherein transmitting a first request an embedded device further comprises:
generating the first request, wherein the first request further includes a request wrapper; and
transmitting the first request to the embedded device via the first network using the first protocol.

4. A method in accordance with claim 3 wherein transmitting the second request to the second device further comprises:
reading routing information from the first request; and
routing the second request to the second device via the second network using the second protocol, wherein the second request is routed according to the routing information.

5. A method in accordance with claim 2 wherein transmitting a first response to the embedded device further comprises:
interpreting the second request;
generating the first response; and
transmitting the first response to the embedded device via the second network using the second protocol.

6. A method in accordance with claim 2 further comprising:
generating the second response, wherein the second response further includes a response wrapper; and
transmitting the response to the first device via the first network using the first protocol.

7. A system for communicating data over a plurality of networks using a plurality of transport protocols, said system comprising:
a plurality of devices;
at least one embedded device communicatively coupled to a first device of said plurality of devices via a first network and to a second device of said plurality of devices via a second network, said at least one embedded device configured to:
receive a first request from said first device using a first transport protocol, wherein the first request comprises a second request formatted according to a second transport protocol; and
transmit the second request to said second device using the second protocol.

8. A system in accordance with claim 7 wherein each device of said plurality of devices is configured to generate the first request, wherein the first request further comprises a request wrapper.

9. A system in accordance with claim 8 wherein the request wrapper comprises routing information for transporting the second request through said at least one embedded device to said second device.

10. A system in accordance with claim 9 wherein said at least one embedded device is further configured to:
process the routing information from the second request; and
transmit the second request to said second device according to the routing information and using the second transport protocol.

11. A system in accordance with claim 10 wherein said second device is configured to:
interpret the second request;
generate a first response, the first response formatted according to the second transport protocol; and
transmit the first response to said at least one embedded device using the second transport protocol.

12. A system in accordance with claim 11 wherein said at least one embedded device is further configured to:
generate a second response comprising the first response and a response wrapper; and
transmit the second response to said first device using the first transport protocol.

13. A system in accordance with claim 12 wherein the response wrapper comprises a count of responses to the first request and a network address corresponding to said second device.

14. A system in accordance with claim 7 wherein said at least one embedded device is an automation controller.

15. A method for using an embedded device to transport protocol data units (PDUs) of multiple protocols over multiple networks, the embedded device including at least one network interface configured to communicate with a first device of a plurality of devices via a first network using a first protocol and with a second device of the plurality of devices via a second network using a second protocol, said method comprising:
receiving a request from the first device via the first network using the first protocol, the request including a request PDU formatted according to the second protocol; and
routing the request PDU to the second device, wherein the request includes a network address of the second device, and wherein the request PDU is routed to the second device via the second network using the second protocol.

16. A method of operating an embedded device in accordance with claim 15, said method further comprising:
receiving a response PDU from the second device via the second network using the second protocol;
routing the response PDU to the first device via the first network using the first protocol.

17. A method of operating an embedded device in accordance with claim 15 wherein receiving a request from the first device further comprises packaging the request PDU and a request wrapper to generate the request, wherein the request wrapper includes routing information for transporting the request PDU to the second device.

18. A method of operating an embedded device in accordance with claim 17 wherein routing the request PDU to the second device further comprises:
reading the routing information from the request PDU; and
transmitting the request PDU to the second device using the routing information, wherein the request PDU is transmitted through the at least one network interface to the second device via the second network using the second protocol.

19. A method of operating an embedded device in accordance with claim 16 wherein routing the response PDU to the first device further comprises packaging the response PDU and a response wrapper to generate a response, wherein the response wrapper includes a count of response PDUs and a network address for each response PDU corresponding to the second device.

20. A method of operating an embedded device in accordance with claim 19 wherein the embedded device is an automation controller, said method further comprising routing the response to the first device via the first network using the first protocol.
